(19) United States
(12) Patent Application Publication
(10) Pub. No.: US 2014/0317009 A1
(43) Pub. Date: Oct. 23, 2014

(54) Managing Online and Offline Interactions Between Recruiters and Job Seekers

(71) Applicant: Pangea Connect, Inc., Needham, MA (US)

(72) Inventors: Paul Bilodeau, Charlestown, MA (US); Andrew Gelina, Bridgewater, MA (US)

(73) Assignee: PANGEA CONNECT, INC, Needham, MA (US)

(21) Appl. No.: 14/166,955

(22) Filed: Jan. 29, 2014

Related U.S. Application Data
(60) Provisional application No. 61/814,668, filed on Apr. 22, 2013.

(51) Int. Cl. G06Q 10/10

(52) U.S. Cl. CPC G06Q 10/1053
USPC 705/321

(57) ABSTRACT

Systems and methods for managing interactions between users to allow for a more effective online employment process are disclosed. In an aspect, the system includes a portal containing various databases and allows employers and prospective employees to create profiles, create and search for job postings, and create and take exams and interviews. In another aspect, system includes processes which can assist in these steps by using an automated system to grade and score tests and interviews, generate test questions based on the type of the job posting, and perform automated matching between users based on commonalities. In yet another aspect, user profiles may be connected to update feeds and social media sites in order to automatically pull updates from such sites to ensure that a prospective employee's profile remains up-to-date.

### CROSS REFERENCE TO RELATED APPLICATION

This application claims the benefit of U.S. Provisional Patent Application No. 61/814,668, filed Apr. 22, 2013, and entitled “Managing Online and Offline Interactions Between Recruiters and Job Seekers”, the entire contents of which is incorporated herein by reference.

### FIELD OF THE DISCLOSURE

The present disclosure generally relates to human resources systems, and more particularly to systems, methods and computer program products for managing interactions between users to allow for a more effective online employment process.

### BACKGROUND

The statements in this section merely provide background information related to the present disclosure and may not constitute prior art.

In the technological world that we live in, a large number of individuals looking for employment by initially searching online. Using employment-related websites such as Monster.com, SimplyHired.com, Dice.com, and LinkedIn, prospective employees search for possible employment based on geographic locations, salaries, skill sets required, educational requirements, and other factors.

After limiting the search results, the prospective employee may find what they consider the perfect position. The prospective employee chooses to apply for that position. Thus, they upload all of required application documents (e.g., resume, cover letter, transcripts, writing samples, or the like) in order to apply. After applying for the position, however, the prospective employee does not hear back nor know what part of their qualifications was lacking for the specific employer. This story is largely the same regardless of the employment-related website that is used. In fact, under current recruiting models, up to 96% of job seekers only ever receive a “thank you” email after applying for a job online. Further, only 10% of companies respond to all employment candidates. Very few employment candidates receive any feedback or are able to deduce any reason as to why they did not get the job.

Given the foregoing, systems, methods and computer program products are needed that facilitate the management of interactions between users to allow for a more effective online employment process. Such systems, methods and computer program products should provide a way to assist prospective employees in finding employment, as well as to assist employers in finding the most qualified employees for any posted positions.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products for managing interactions between users to allow for a more effective online employment process.

In an aspect, systems, methods, and computer program products for facilitating the job interview process are disclosed that includes a job database, an interview database, and a candidate database that users, such as job seekers and employers, can use to search for other users. For example, a first user may be a job seeker searching for a job and a second user may be an employer searching for a prospective employee. The second user can post a job opening in the job database which the first user can search and then submit an application for the opening. The first user can then search the job database and apply for the job opening.

In an aspect, the system would provide the first user and the second user the ability to fully perform the interview process by, for example, testing the first user's qualifications; interviewing the first user, including the ability to match automated questions to interview subjects; grading the qualification tests; transcribing audio and video; analyzing non-verbal cues; and enabling game-like scoring for these activities.

In another aspect, the first user can maintain a user profile which defines their qualifications and stores documents such as, but not limited to, a resume and letters of recommendation. The first user's profile can be linked to external feeds, including social network sites such as Facebook, Twitter, LinkedIn, and the like, which allows the first user to push profile updates such as, but not limited to, updating first user's resume, adding or removing letters of recommendation, adding or removing job interests, adding or removing geographic locations of interest, adding or removing job qualifications, or the like.

In yet another aspect, a mobile device can be utilized to improve the employment process. Systems of the present disclosure create a scanning label, such as a barcode, QR-code, DataMatrix, Cool-Data-Matrix, Aztec, UPCode, Trillcode, Shotcode, mCode, Beetagg, and the like. A first user can either electronically display or print out a personalized scanning label and provide the scanning label to a second user at, for example, a job fair or like event. The second user then can utilize his mobile device to “scan” the scanning label to link the second user directly to the profile of the first user. In the inverse, a second user can provide a first user with a scanning label which links the first user to a job posting on the system, the second user's corporate webpage, or the like.

In yet another aspect, the mobile device's location tracking mechanism can update the job postings on the system by including the first user's geographic location to update the geographic locations of interest within the first user's profile.

Further features and advantages of the present disclosure, as well as the structure and operations of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for managing the online and offline interactions between users to allow for a more effective job-related interviewing process, according to an aspect of the present disclosure.

FIGS. 2A-2O are flow charts illustrating exemplary uses of the system for managing the online and offline interactions between users, according to various aspects of the present disclosure.

FIG. 3 is a block diagram of an example computing system useful for implementing the present disclosure.

FIGS. 4A-4D are screenshots illustrating exemplary graphical user interface windows, according to various aspects of the present disclosure.

### DETAILED DESCRIPTION

The present disclosure is directed to systems, methods, and computer program products for managing interactions between users to allow for a more effective job-related interviewing process.

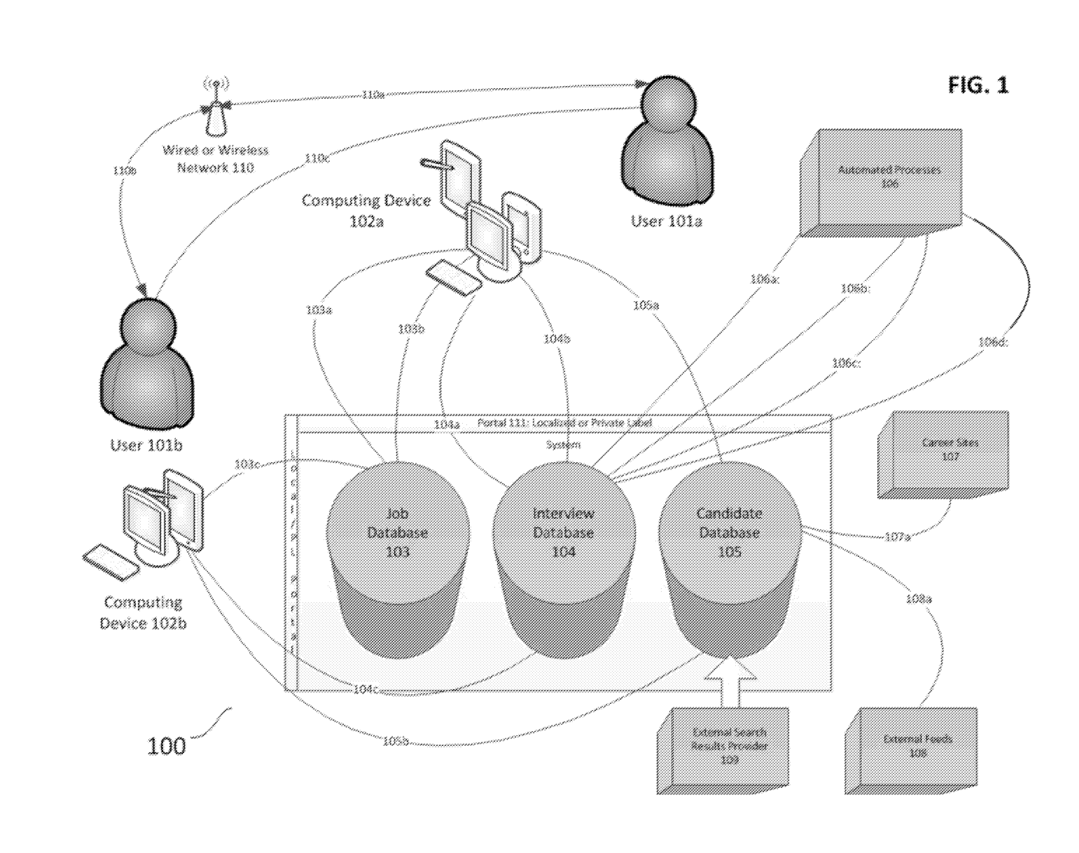

Referring now to FIG. 1, a block diagram of an exemplary system 100 for managing the online and offline interactions between users to allow for a more effective job-related interviewing process, according to an aspect of the present disclosure, is shown.

In an aspect of the present disclosure, user 101a and user 101b access a portal 111 using computing device 102a and 102b, respectively. In various aspects, computing device 102 may be configured as a mobile telephone, a laptop computer, a gaming console, a desktop computer, a Personal Digital Assistant (PDA), a smartphone, a tablet, a mobile computer, any commercially-available mobile intelligent communications device or the like.

In one aspect, portal 111 may be localized or a private label portal and contain multiple databases such as, but not limited to, a job database 103, an interview database 104, a candidate database 105, as well as any other databases that would be useful based on an aspects of the present disclosure as will be apparent to those skilled in the relevant art(s) after reading the description herein.

In another aspect of the present disclosure, user 101a and user 101b may interact with job database 103, interview database 104, and candidate database 105 through actions 103a, 103b, 103c, 104a, 104b, 104c, 105a, and 105b, wherein the processes may be actions such as, but not limited to, searching for jobs; discovering jobs by location; narrowing jobs by: (i) salary, (ii) level of skill required, (iii) level of education required, (iv) geographic location, (v) amount of experience required, (vi) amount of travel required, or (vii) any other narrowing factor(s) as will be apparent to those skilled in the relevant art(s) after reading the description herein; uploading new job postings; taking tests; interviewing; watching interviews; rating interviews; creating a profile; controlling facets of a profile; searching for potential employees; or any other process(es), as will be apparent to those skilled in the relevant art(s) after reading the description herein. In such aspects, profiles stored in candidate database 105 may provide search results when searched on external search results provider 109 (e.g., an Internet search engine).

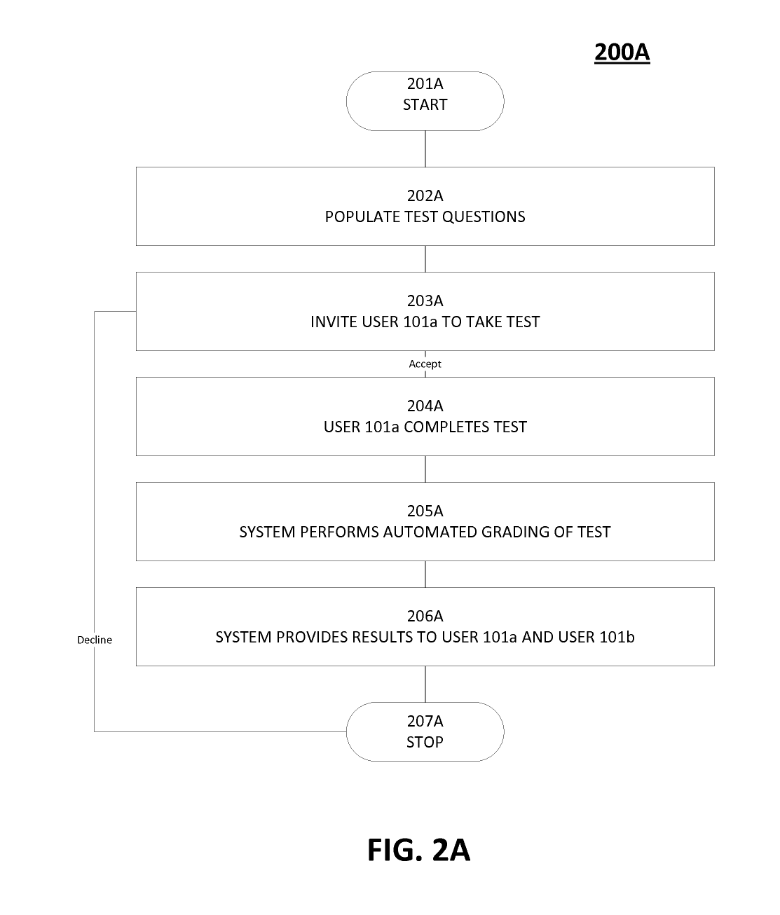

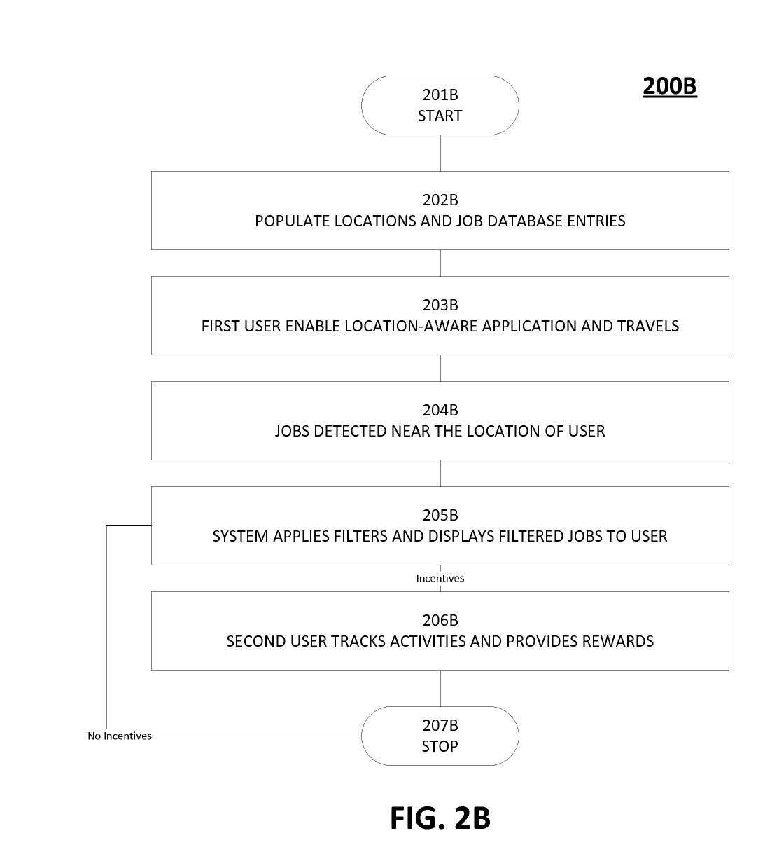

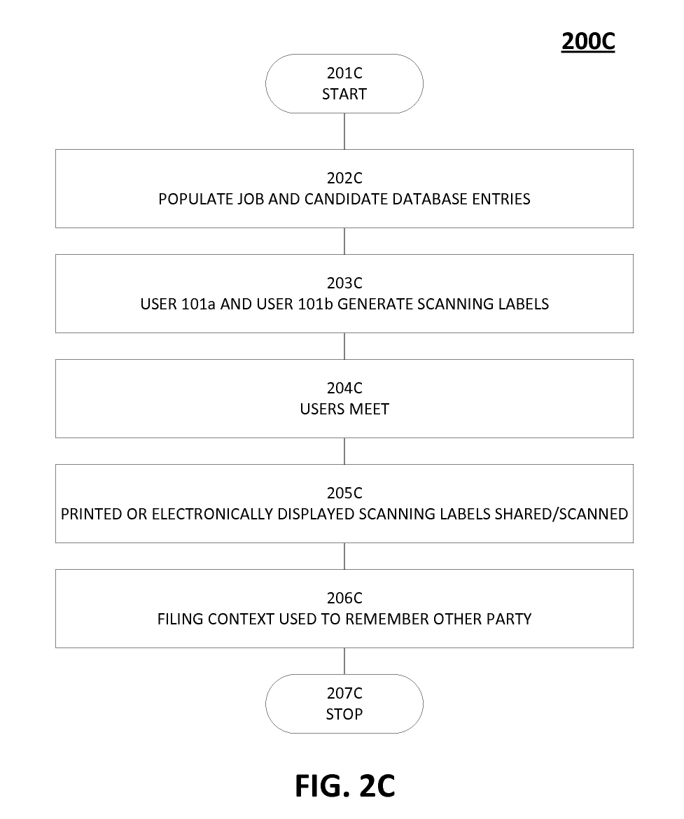

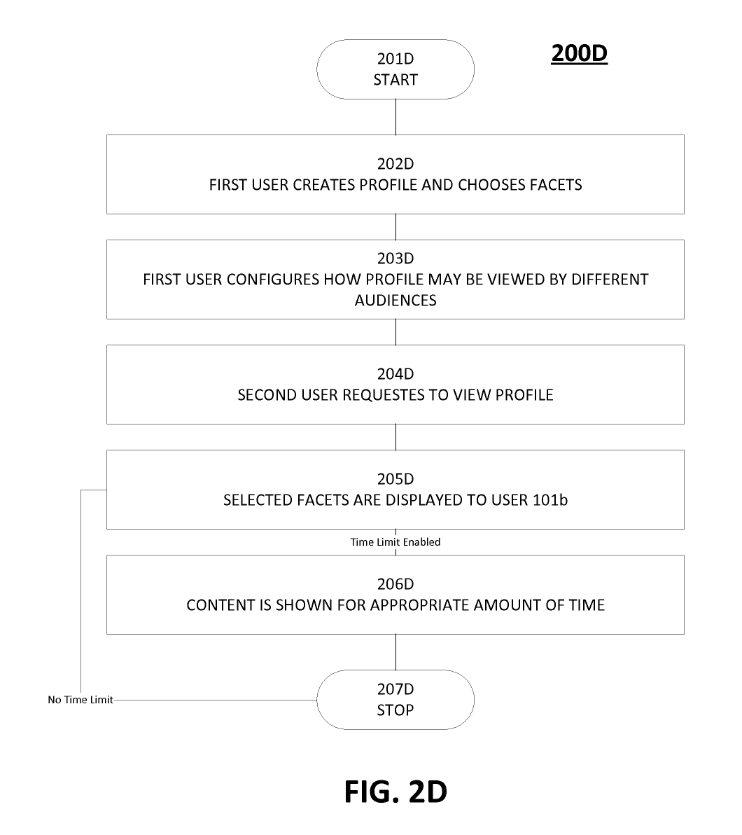

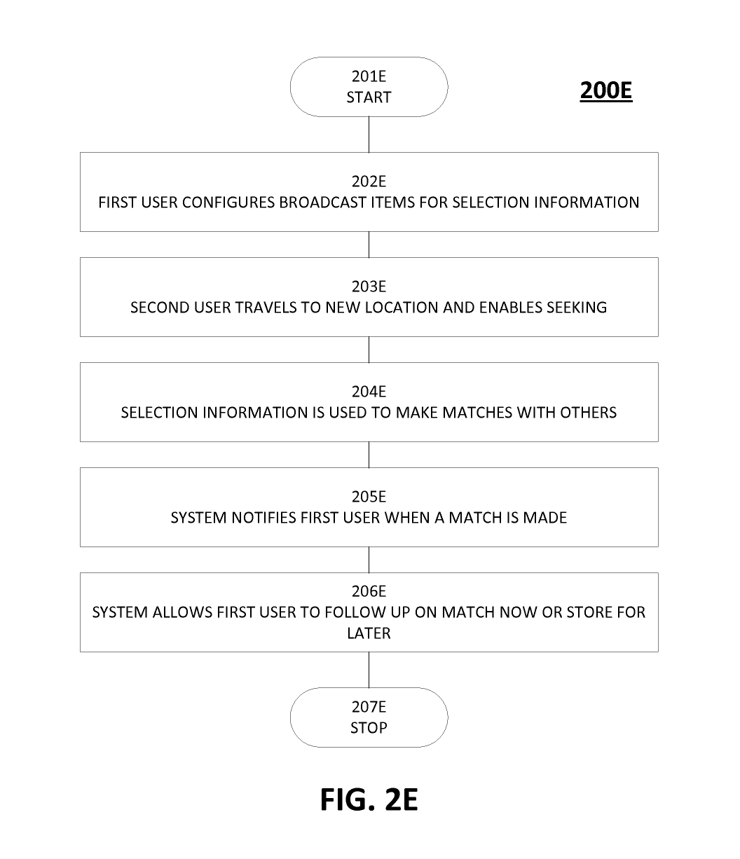

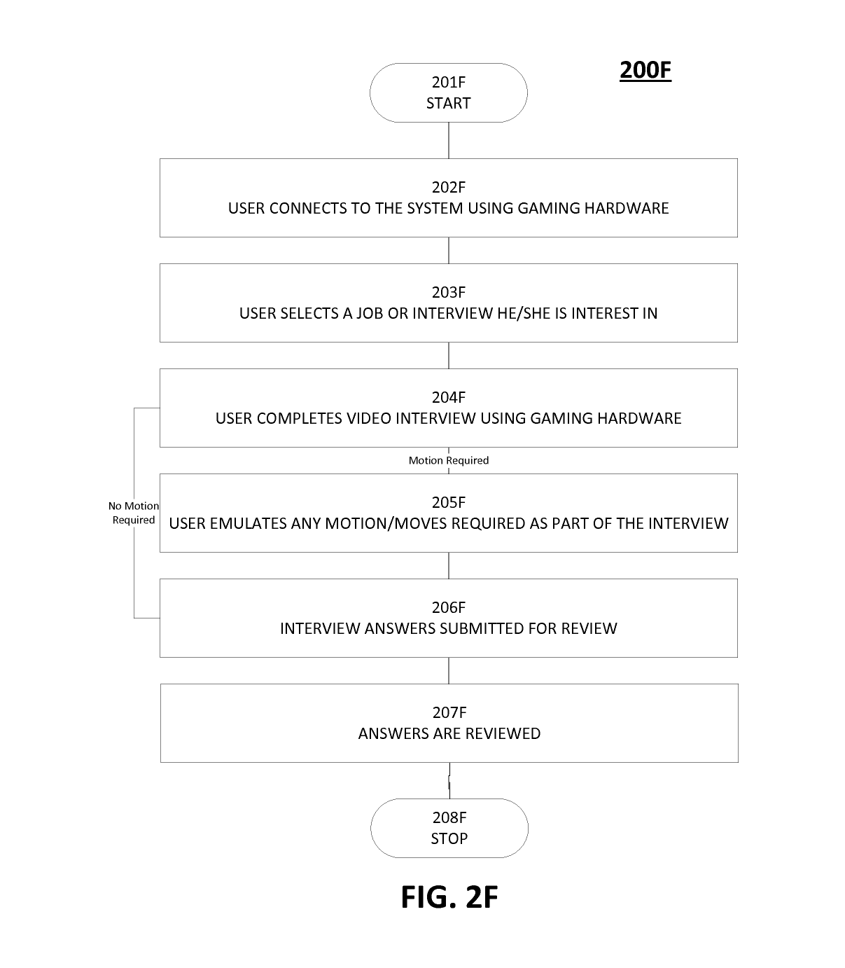

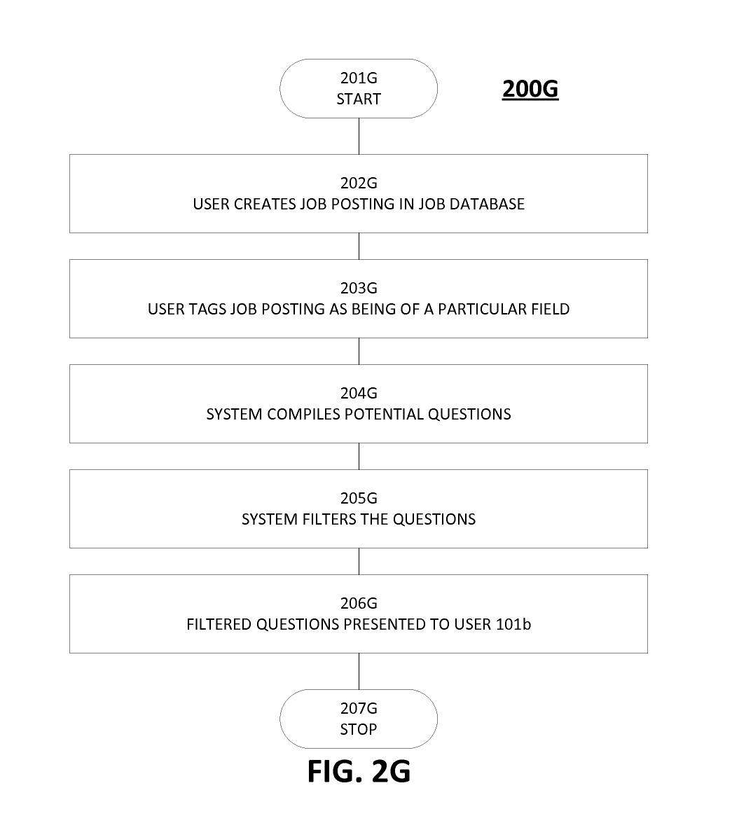

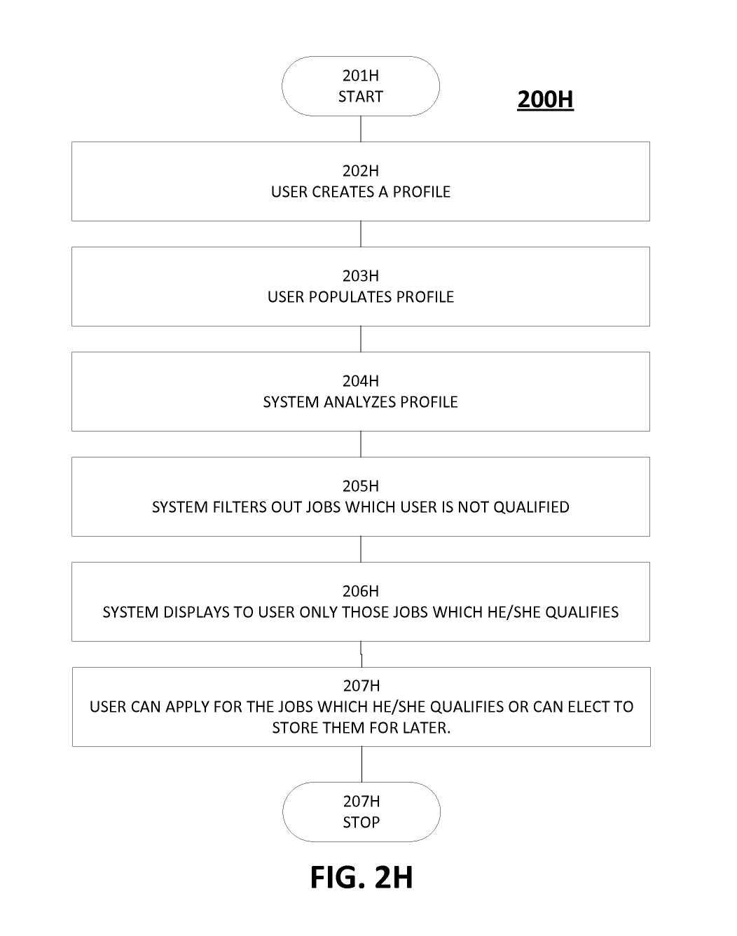

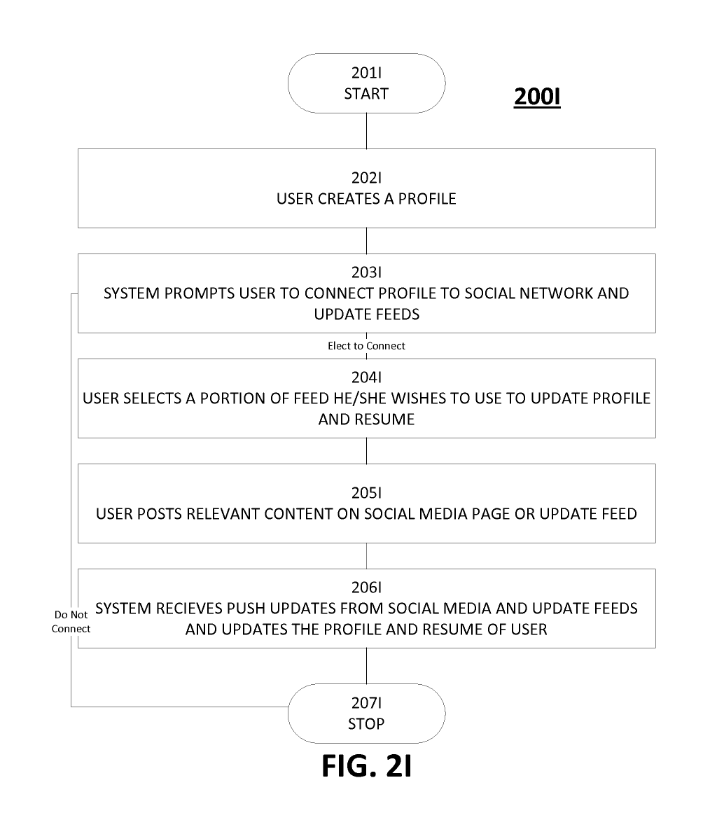

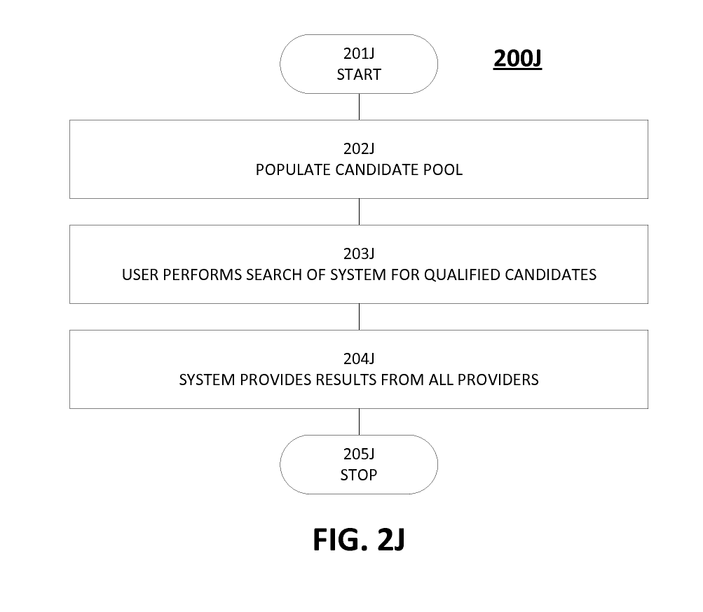

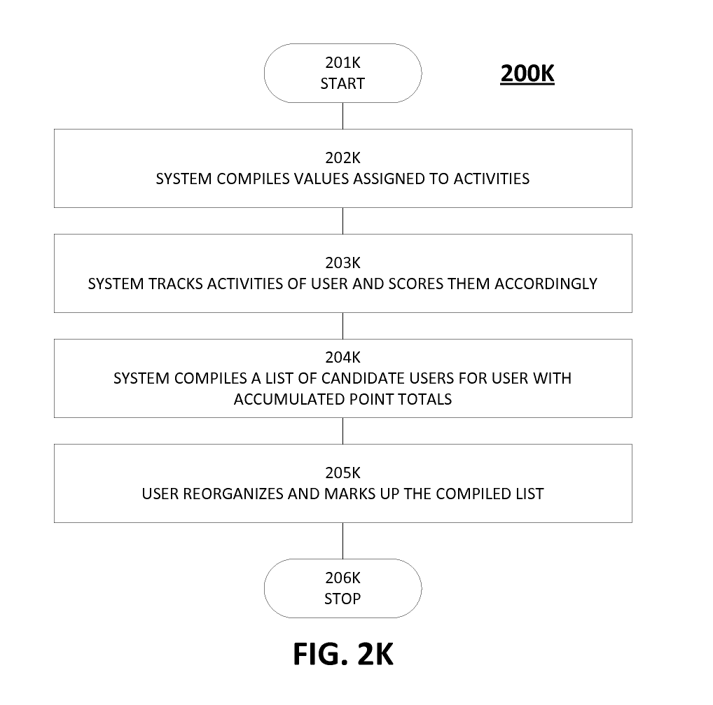

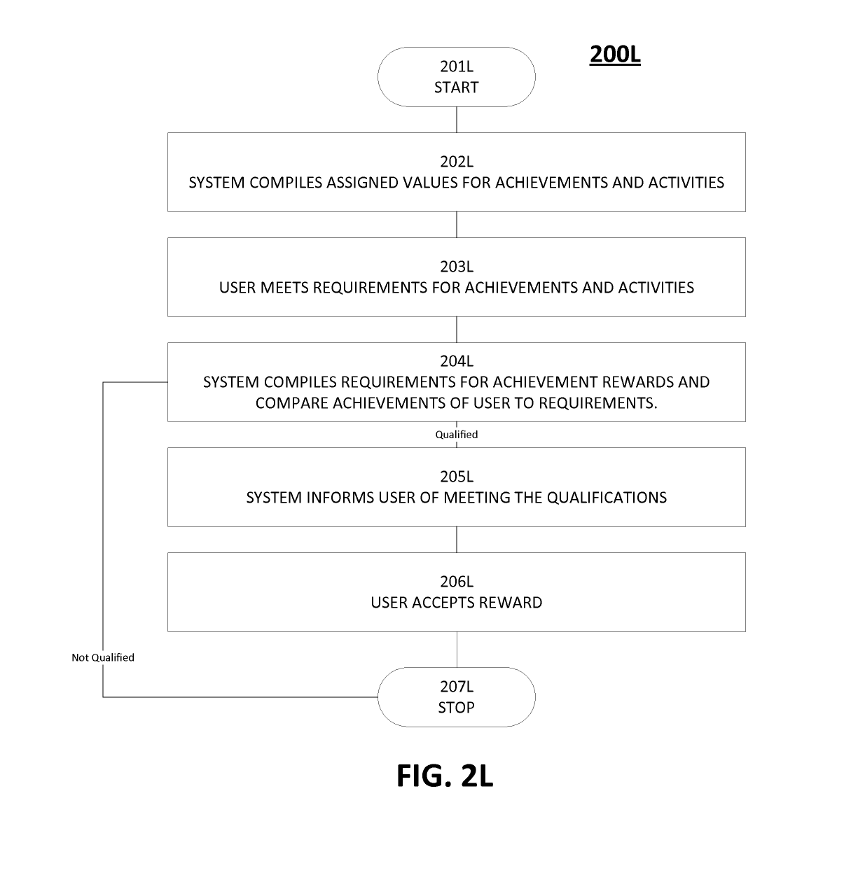

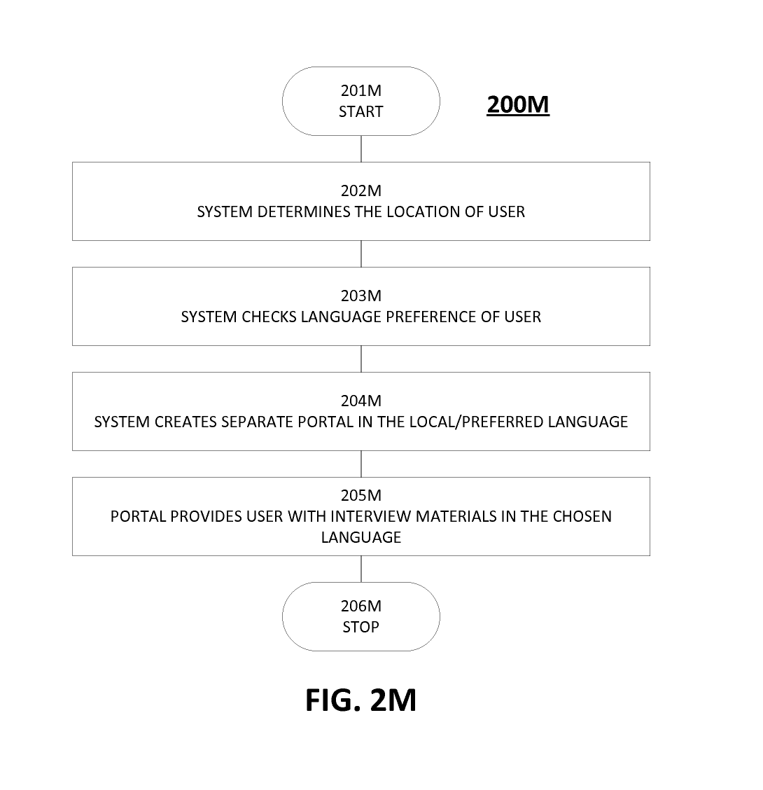

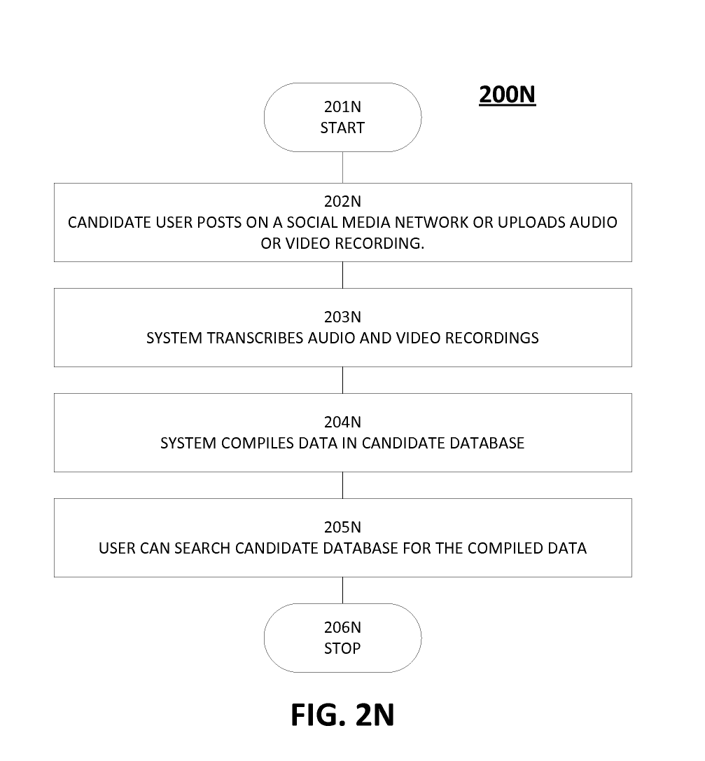

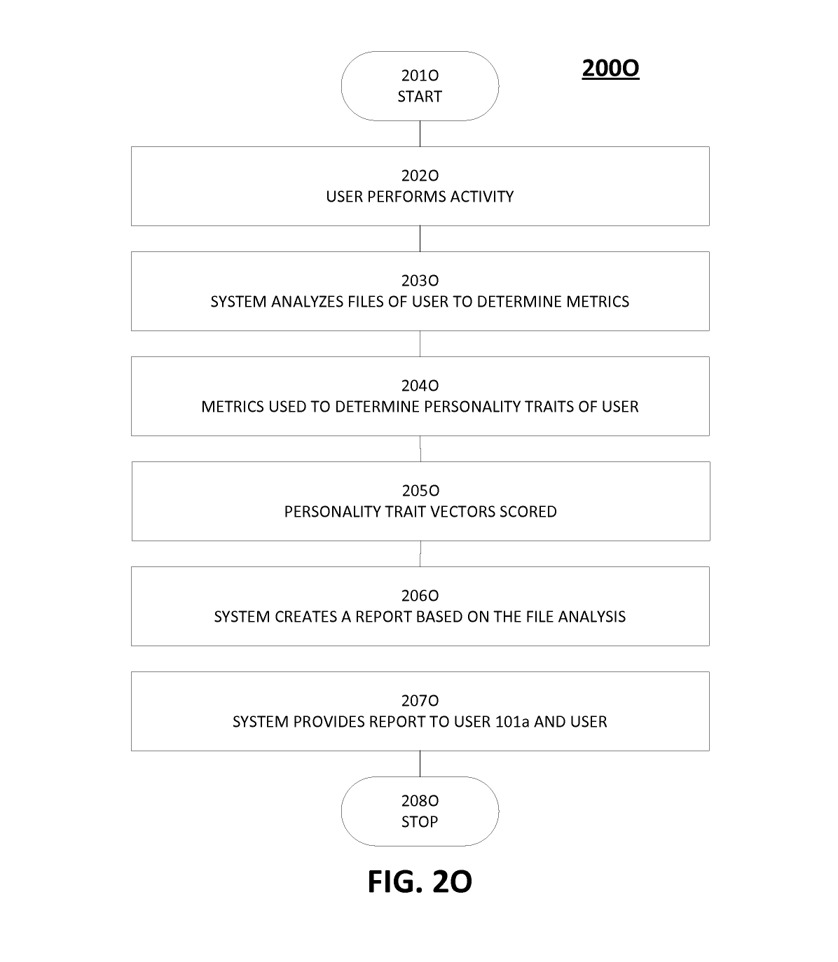

In yet another aspect of the present disclosure, interview database 104 may perform one or more automated processes 106. Automated processes 106 allow system 100 to automatically perform processes 106a, 106b, 106c, and 106d. Processes 106a, 106b, 106c, and 106d may include processes such as, but not limited to: (i) grading completed tests, (ii) determining the type of the job posting based on the information in the post, (iii) matching questions to job interviews based on the job type, (iv) transcribing audio and video files, (v) analyzing non-verbal cues in audio and video files, (vi) scoring activities of user using a game-like scoring method, or (vii) any other process useful according to aspects of the present disclosure. (Specific examples of automated processes 106 are detailed below with reference to FIG. 2).

In yet another aspect of the present disclosure, candidate database 105 may interact with career sites 107 and external feeds 108. External fees 108 may be set up as update feeds or social network sites such as, but not limited to, Facebook, Twitter, Google+, LinkedIn or the like. Through process 107a system 100 may, for example, tailor a career site based on an archetype to assist in the job finding process. System 100 may also be configured to pull profile and resume updates from external feed 108 to a user profile stored in candidate database 105.

In yet another aspect of the present disclosure, system 100 may include a wired or wireless network 110 so that user 101a and user 101b may send broadcast messages 110a, 110b to each other. According to an aspect of the present disclosure, users 101a, 101b may communicate without using a wired or wireless network 110 through process 110c. Process 110c may be, for example, exchanging contact information or scanning labels produced by system 100 in order to improve the chances of finding a qualified prospective employee for a particular job posting.

As will appreciated by those skilled in the relevant art(s), in an aspect, various screens would be generated by one or more web servers (not shown in FIG. 1) within portal 111 in response to input from users 101. That is, in such an aspect, system 100 includes one or more typical web servers running server applications at a website which send out webpages, while performing processes 106, in response to Hypertext Transfer Protocol (HTTP) or Hypertext Transfer Protocol Secured (HTTPS) requests from remote browsers on computing devices 102 being used by various users 101. Thus, portal 111 is able to provide a graphical user interface (GUI) to users 101 of system 100 in the form of webpages. These webpages are sent to the user's computing devices 102, and would result in the GUI being displayed.

As will be appreciated by those skilled in the relevant art(s) after reading the description herein, alternate aspects of the present disclosure may include providing the tools for facilitating the management of interactions between users to allow for a more effective job-related interviewing process via an installed application, a browser pre-installed with an applet or a browser with a separately downloaded applet on computing system 102. That is, as will also be apparent to one skilled in the relevant art(s) after reading the description herein, an applet that facilitates the interaction management solution disclosed herein may be part of the “standard” browser that ships with computing system 102 or may be later added to an existing browser as part of an “add-on,” or “plug-in,” or may be added as a separate mobile application software (“app”) capable of executing on computing system 102 after an “app store download.”

As will also be appreciated by those skilled in the relevant art(s) after reading the description herein, in an aspect of the present disclosure, an application service provider—an individual person, business, or other entity—may allow access, on a free registration, paid subscriber and/or pay-per-use basis, to the infrastructure of system 100 (and thus, automated processes 106) via one or more World-Wide Web (WWW) sites (or portals 111) on the global, public Internet. Thus, system 100 is scalable to accommodate a plurality of users 101.

Referring now to FIG. 2A, a flow chart of an exemplary process 200A for integrating automated testing into an online job application or video interview, according to an aspect of the present disclosure, is shown.

Process 200A begins at step 201A and immediately proceeds to step 202A. In step 202A, system 100 populates test questions. These questions may be in written form, video form, audio form, or any other format appropriate for utilization in process 200A, and may be specified by user 101b or they may be predetermined by system 100 based on the “job type” of the posting as identified by either user 101b or through an internal set of algorithms. Upon completion of the question population, process 200A then proceeds to step 203A.

In step 203A, user 101a is invited to take a particular test. The invitation may be sent by user 101b, sent by a third party, sent by an outside system, or sent because system 100 has analyzed the profile user 101a and determined that user 101a qualifies for the particular position in question. User 101a may then choose to take the test, decline to take the test, or to store the invitation for a later date. When user 101a decides to accept the invitation to take the test, process 200A proceeds to step 204A where user 101a completes the suggested test. If user 101a chooses to decline the invitation, process 200A terminates at step 207A.

Upon completion of a test in step 204A, process 200A proceeds to step 205A where system 100 uses parsers, compilers, and algorithms to automatically grade the submitted test. Process 200A then proceeds to step 206A where system 100 provides the test results to both user 101a and user 101b before process 200A terminates at step 207A. Once process 200A terminates, user 101a and user 101b can review the results of the test and determine whether there is a desire to continue the interview process any further with that particular individual or organization.

Referring now to FIG. 2B, a flow chart of an exemplary process 200B for allowing user 101a to discover and apply for available jobs based on that user's particular location, according to an aspect of the present disclosure, is shown.

Process 200B begins at step 201B and immediately proceeds to step 202B. In step 202B, system 100 compiles a list of job postings in job database 103 and maintains them in a manner which divides the job postings by geographic location (e.g., by country, state, city, zip code, region, etc.). Process 200B then proceeds to step 203B where user 101a activates an application of their location-aware device such as, but not limited to, a location aware computing device 102 (e.g., mobile telephone, tablet computer). The application can continuously determine the present location of user 101a. Process 200B then proceeds to step 204B.

In step 204B, system 100 locates job postings near the location of user 101a. Once user 101a enters a location within a predetermined proximity of the business location determined by user 101b, process 200B proceeds to step 205B where system 100 applies filters that user 101a has applied to his profile. Such filters may include, but are not limited to, industry type, company size, skills requirements, interests, salary, geographic radius, or other parameters to control which job postings are to be displayed.

If the job posting still meets the requirements of the filters of user 101a, system 100 then generates a notification and sends the notification to user 101a to alert them of the job posting. This notification may cause location-aware computing device 102 of user 101a to perform an action based on the settings preferences user 101a has set on computing device 102 such as, but not limited to, causing a light to flash, causing the location-aware device to vibrate, causing the GUI to display a notification bar, or any other feature the location-aware device may use to notify user 101a.

Upon viewing the notification, user 101a can elect to get more information on the job posting, view other job postings posted by user 101b, or apply for one or more of the job postings while still using the same location-aware device. Process 200B then terminates at step 207A unless user 101b elected to provide incentives to job applicants.

If user 101b elected to provide incentives to job applicants, process 200B proceeds to step 206B. In step 206B, system 100 tracks the activities and actions performed by user 101a and compare them to the requirements set by user 101b in order to prompt a reward offer. Such requirements set by user 101b may include, but are not limited to, a requirement to apply for a particular amount of positions posted by user 101b; and such rewards may include, but are not limited to, free products, text coupon codes, barcodes that drive discounts, guaranteed first interviews, or any other incentive which may be delivered via the location-aware device 102 or by physical means. Process 200B then terminates at step 207B.

Referring now to FIG. 2C, a flow chart of an exemplary process 200C for allowing users 101 to scan labels in order to quickly swap contact information and indicate interest in following up with one another on employment opportunities, according to an aspect of the present disclosure, is shown.

Process 200C begins at step 201C and immediately proceeds to step 202C. In step 202C, system 100 populates job posting- and potential candidate-related data in job database 103 and candidate database 105, respectively, and then proceeds to step 203C. In step 203C, system 100 allows user 101a and user 101b to generate a scanning label such as, but not limited to, a bar code, a QR-Code, a DataMatrix, a Cool-Data-Matrix, an Aztec Code, a UPCODE, a Trillcode, a Shotcode, an mCode, a Beetagg, or any other scanning label capable of performing the quick transfer of information as needed by various aspects of the present disclosure.

Process 200C then proceeds to step 204C where user 101a and user 101b meet. This meeting may be a physical meeting at a location such as a job fair where user 101a can display the scanning label to user 101b by either providing user 101b with a printed hardcopy of the scanning label or display the scanning label on a portable electronic device (e.g., a smartphone). As will be understood by those skilled in the relevant art(s), this meeting may also be an “electronic meeting” resulting in an exchange of the scanning label through means such as, but not limited to, an email, a facsimile, an MMS message or the like.

Process 200C then proceeds to step 205C where user 101a or user 101b provides the scanning label to the other user. This display can be a physical display such as a hardcopy print out or can be an electronic display on a portable electronic device. The provided scanning label can then be scanned utilizing, for example, an application installed on the user's mobile device. Scanning the label may, for example, send user 101a to a particular job posting linked to the label received from user 101b, or send user 101b to online profile of user 101a. Process 200C then proceeds to step 206C.

In step 206C, user 101a or user 101b can create a filing context, such as a connections list, in connection to the scanning label to indicate to themselves as to why they considered or did not consider the particular job posting or prospective employee. The filing context may be, for example, “John Smith highly recommends this candidate” or “Jane Doe highly discourages pursuing employment with this employer.” The user who created the filing context can then rate and organize the connections made by creating different folders which can be categorized, for example, by date, by job fair, by geographic region, or by any other filing taxonomy which helps the user to organize the connections that were made. Process 200C then terminates at step 207C.

Referring now to FIG. 2D, a flow chart of an exemplary process 200D for allowing a user to control an online profile and portfolio, with the ability to pick and choose which facets are shown (or hidden) to other users, according to an aspect of the present disclosure, is shown.

Process 200D begins at step 201D and immediately proceeds to step 202D. In step 202D, user 101a creates a profile and chooses various facets such as, but not limited to, employment field of interest, geographic region of interest, relevant skills possessed, prior work history, resume, video profile, video interview, social media content, or any other facet useful in creating a profile. Process 200D then proceeds to step 203D where user 101a may elect to show or hide multiple versions of any of the facets such as, for example, only allowing certain users to view a particular resume or set of responses to a video interview.

Process 200D then proceeds to step 204D when a user submits a request to system 100 by, for example, using a mouse to click on the user's profile. System 100 then identifies the type of user requesting to view the profile of user 101a and proceeds to step 205D where system 100 filters the facets to only display the appropriate facets based on the user attempting to access the profile. Process 200D then terminates at step 207D unless user 101a elected to limit the amount of time a requesting user may view the facets of the profile of user 101a. In such a circumstance, process 200D proceeds to step 206D where the facets may only be displayed for the appropriate amount of time before proceeding to step 207D.

As will be recognized by those skilled in the relevant art(s), user 101b can also be the profile creator. In such an aspect, the various facets may include, but are not limited to, one or more job postings, company size, company benefits, business locations, or any other information that may be relevant to attract potential applicants to their job postings.

Referring now to FIG. 2E, a flow chart of an exemplary process 200E for allowing a user in a given location to broadcast his information to other users using mobile devices, according to an aspect of the present disclosure, is shown. The physical location may be ad hoc or a coordinated event and the information broadcasted may include, but are not limited to, pseudonym, picture, video, contact information, interests, skills or any other relevant information.

Process 200E begins at step 201E and immediately proceeds to step 202E. In step 202E, user 101a or user 101b configures their profile to allow for the broadcasting of selected information. Process 200E then proceeds to step 203E when user 101a, the first user, or user 101b, the second user, travels to a new location such as, but not limited to, a job fair. While at the location, user 101b may elect to enable the broadcasting of the selected information before process 200E proceeds to step 204E.

In step 204E, system 100 compares the broadcasted information of all users and matches the qualifications of the job-seeking users with the requirements of the job-posting users in order to “match” them to one another. System 100 may then record the matches across multiple physical encounters to build a history of the people or entities that each user has been matched with over time. Process 200E then proceeds to step 205E where system 100 generates and sends both matched users a notification of the match and encourages contact such as, but not limited to, online contact, online conversations, exchanging contact information, bookmarking the match, meeting via SMS text messaging, a telephone call, a face-to-face encounter or any other contact which may be appropriate.

Process 200E then proceeds to step 206E where a user can either act upon the match by contacting the other user in an appropriate manner, or the user may elect to store the match and not contact the other user until a later time. Upon either leaving the location or the broadcasting being manually or automatically disabled (based on the preferences of user 101a or user 101b), process 200E terminates at step 207E.

Referring now to FIG. 2F, a flow chart of an exemplary process 200F for allowing a user to interview remotely using motion, audio, and video capture hardware from a gaming system, according to an aspect of the present disclosure, is shown.

Process 200F begins at step 201F and immediately proceeds to step 202F. In step 202F, user 101a connects to portal 111 using a gaming console as a computing device 102, such as Microsoft Kinect® (available from Microsoft Corp. of Redmond, Wash.), with motion capture, audio capture, video capture or any combination of the three. Process 200F then proceeds to step 203F when user 101a selects a job posting or interview they are interested in completing before proceeding to step 204F. Using the gaming console, user 101a can read questions, listen to questions, or watch questions and then respond to the questions using text, audio, video or any combination of the three.

Upon completion of the application or interview using audio, text, video or a combination of the three, process 200F proceeds to step 206F, unless user 101b has instructed system 100 that a portion of the interview requires user 101a to perform a particular type of motion such as, but not limited to: requiring an athlete to simulate a throw, catch or exercise; requiring a dancer to perform a step, turn, kick or other type of dance move; requiring a model to perform certain looks, walks, turns or pose; or any other requirement for which testing motions would be desirable and relevant to a job opening. These moves may be requested in real time or user 101a may be given the list of requisite moves prior to entering the interview or job application process. If a motion is requested, process 200F would proceed to step 205F before proceeding to step 206F.

In step 206F, user 101a submits their answers before process 200F proceeds to step 207F where system 100 scores the text, audio and video answers in the manner described in process 200A and performs automated rating of the motions to determine how closely user 101a matched the model motion (i.e., the “model answer”) presented to them. Process 200F then terminates at step 208F.

As will be understood by those skilled in the relevant art(s), the gaming console may also be utilized to facilitate an interview in real time with user 101b, providing a platform to share text, audio, video, motions or any combination thereof directly between user 101a and user 101b.

Referring now to FIG. 2G, a flow chart of an exemplary process 200G for determining which interview questions to use for a given job based on the text and video content of a job posting and the associated job tags, according to an aspect of the present disclosure, is shown.

Process 200G begins at step 201G and immediately proceeds to step 202G. In step 202G, user 101b creates a job posting to be stored in job database 103. Then in step 203G, user 101b associates “tags” to the job posting which are designed to indicate that the job posting is a job posting for, for example, a particular industry or requires particular skills. Alternatively, or in addition to the tags associated with the job posting by user 101b, system 100 inspects the text and video content of the job posting to determine the appropriate tags to associate to the job posting.

Process 200G then proceeds to step 204G where system 100 compiles a list of all possible questions that may be presented to an applicant without regard to any of the associated tags before proceeding to step 205G. In step 205G, system 100 filters out the questions by matching appropriate interview questions to the job postings. These questions may be text, audio, video or any combination of the three. These questions may also be categorized as single questions or question sets. Process 200G then proceeds to step 206G where the questions are presented to user 101a before process 200G terminates at step 207G.

Referring now to FIG. 2H, a flow chart of an exemplary process 200H for tailor a career site based on an archetype, according to an aspect of the present disclosure, is shown.

Process 200H begins at step 201H and immediately proceeds to step 202H. In step 202H, user 101a creates a profile before process 200H proceeds to step 203H where user 101a populates the profile. User 101a may populate the profile manually or it may be automatically populated based on content from social media sites such as, but not limited to, Facebook, Twitter, LinkedIn and the like. Process 200H then proceeds to step 204H where system 100 analyzes the profile before proceeding to step 205H.

In step 205H, system 100, using the information obtained for the profile of user 101a, filters out job postings for which user 101a may not be qualified before proceeding to step 206H. In step 206H, system 100 displays to user 101a only the jobs for which they may qualify. Then, in step 207H, user 101a can elect to apply for, store for later, or pass on any of the job postings for which they may qualify before process 200H terminates at step 207H.

Referring now to FIG. 2I, a flow chart of an exemplary process 200I for allowing a job seeker to keep their online profile or resume constantly up-to-date by using information from social media sites and update feeds, according to an aspect of the present disclosure, is shown.

Process 200I begins at step 201I and immediately proceeds to step 202I. In step 202I, user 101a creates a profile which is stored in candidate database 105. Then, in step 203I, system 100 prompts user 101a to connect the profile with a social media site such as, but not limited to Facebook, Twitter, LinkedIn or the like, or an update feed before proceeding to step 204I. In step 204I, user 101a elects to use all, part or none of the social media or update feed data to update their profile. If user 101a elects to not connect the profile to any social media sites or update feeds, or elects to use none of the social media site or update feed content to update their profile, process 200I terminates at step 207I. Otherwise, process 200I proceeds to step 205I.

In step 205I, user 101a, using a social media site or update feed, posts relevant content such as, but not limited to, a change in their work experience, volunteer activity, education, interests, skills, qualifications or any other information in their profile. Then, in step 206I, system 100 receives push updates from the social media site and update feeds, and updates the profile and resume of user 101a within candidate database 105. Process 200I then terminates at step 207I.

Referring now to FIG. 2J, a flow chart of an exemplary process 200J for allowing recruiters to simultaneously search multiple candidate sources including an internal candidate database, according to an aspect of the present disclosure, is shown.

Process 200J begins at step 201J and immediately proceeds to step 202J. In step 202J, system 100 populates a candidate pool using candidate database 105 as well as other external job sites such as, but not limited to, LinkedIn, Dice.com, Monster.com and the like. Then, in step 203J, user 101b can perform a search of the candidate pool to search for candidates qualified to fill a particular position. Then, in step 204J, system 100 displays to user 101b a list of qualified candidates from all candidate pool sources in a single result set before process 200J terminates at step 205J. Following the termination of process 200J, as discussed above, user 101b can send qualified users invitations to participate in interviews that are text-based, audio-based, video-based, motion-based or any combination thereof.

Referring now to FIG. 2K, a flow chart of an exemplary process 200K for compiling point values within a rewards system in order to help optimize recruiting interests, according to an aspect of the present disclosure, is shown.

Process 200K begins at step 201K and immediately proceeds to step 202K. In step 202K, system 100 compiles point values that are associated with various activities such as, but not limited to calling or emailing a candidate or potential employer, making contact, submitting a candidate, getting a telephone interview, getting an in-person interview, making placements and any other activity which may occur during the interviewing process. Point values may also include negative values for activities that are discouraged such as, but not limited to, extended periods of inactivity, arriving late for an in-person interview, arriving late for a telephone interview, being unprepared for the interview, not showing up for the interview at all, and any other activity that reflects negatively on any user 101.

Then in step 203K, system 100 tracks the activities of users 101a, b and scores their respective actions and activities according to the scoring compiled in step 202K. Then in step 204K, system 100 compiles a list or “leaderboard” that totals the points each user has earned based on the scoring compiled in step 202K. The total score is compared to other users of the same type (101a or 101b) and a ranking is established, as well as the difference in score between a given user and the leader, and optionally links to activities that may increase that user's score. The total scoring can be adjusted to particular time periods such as, but not limited to, daily points, weekly points, monthly points, yearly points, and “all time” points. Process 200K then proceeds to step 205K. In step 205K, user 101a and user 101b may reorganize the list based on personal favorites and eliminate users from the list that they dislike. The user can further “mark up” the list by, for example, color-coding to indicate which positions represent particular preferences (e.g., employers labeled green indicate that the employer is high on the potential employee's list, while employers labeled red indicates that the employer is low on the potential employee's list). Process 200 then terminates in step 206K.

Referring now to FIG. 2L, a flow chart of an exemplary process 200L for combining game-like scoring, achievement and rewards to help motivate users and develop data, according to an aspect of the present disclosure, is shown.

Process 200L begins at step 201L and immediately proceeds to step 202L. In step 202L, system 100 compiles assigned values for achievements such as, but not limited to, completing writing assignment, publishing a written work, developing a software program or app, or reaching other quantifiable goals, in a manner similar to the manner described in process 200K, then proceeds to step 203L. In step 203L, a user meets the requirements for an achievement-based on their activities (e.g., a potential employee writes an app) and, in step 204L, system 100 compiles the requirement for achievement-based rewards (e.g., completed five achievements) and compares the achievements of the user to the requirement of the achievement-based rewards. If the user has not met the requirements of the achievement-based rewards, process 200L terminates at step 207L.

If the user does qualify for the achievement-based rewards, process 200L proceeds to step 205L where system 100 informs the user that he qualifies for an achievement-based reward such as, but not limited to, achievement badges, guaranteed interviews or any other reward which provides a user with an incentive to participate. Process 200L then proceeds to step 206L where the user accepts the reward before process 200L terminates at step 207L.

Referring now to FIG. 2M, a flow chart of an exemplary process 200M for providing locally-translated versions of an online job portal for the purpose of providing all users a local language version of the job application or online interview process, according to an aspect of the present disclosure, is shown.

Process 200M begins at step 201M and immediately proceeds to step 202M. In step 202M, system 100 determines the location of user 101a via a location-aware device 102 (as discussed above) or via a determination of the departure point of the IP address of the user's computing device 102. Process 200M then proceeds to step 203M where system 100 also checks any language preferences included in the profile of user 101a. Then, in step 204M, system 100 displays a separate portal translated into the local language, the preferred language(s) or both. In step 205M, user 101a can then access all the interview materials (i.e., text, audio and video) that were provided on the original portal, but now they are translated into the desired language(s). Process 200M then terminates at step 206M.

Referring now to FIG. 2N, a flow chart of an exemplary process 200N for allowing recruiters to search candidates based on the transcription of audio or video recordings, or social media posts, according to an aspect of the present disclosure, is shown.

Process 200N begins at step 201N and immediately proceeds to step 202N. In step 202N, user 101a provides a post on a social media site or update feed, or uploads an audio or video recording such as a video interview. Then, in step 203N, system 100 transcribes the audio and video files into searchable text documents. The transcribing of the documents can be done manually or using an automated method supported by system 100. Then, in step 204N, system 100 compiles and stores the transcribed documents and the social media posts in candidate database 105, which in step 205N, user 101b is now able to search while attempting to find potential candidates for a particular job posting. Process 200N then terminates at step 206N.

Referring now to FIG. 2O, a flow chart of an exemplary process 200O for analyzing video of a user answering interview questions to determine non-verbal communication cues, according to an aspect of the present disclosure, is shown.

Process 200O begins at step 201O and immediately proceeds to step 202O. In step 202O, user 101a uploads an audio or video file, participates in a video interview posted by user 101b or performs any other action that results in an audio or video file being available for system 100 to analyze. In step 203O, system 100 analyzes the audio file, video file, or any combination of the two, to determine non-verbal cues such as, but not limited to, speech timber, pitch, posture, gestures, eye contact, eye direction or any other non-verbal cues that may be useful in hiring determination metrics.

In step 204O, the metrics are then used as input into an algorithm that calculates the likelihood that user 101a possesses certain personality traits such as, but not limited to, sincerity, confidence, introversion, or any other trait that may be associated with the non-verbal cues. Then in step 205O, the algorithm produces scores along each trait which indicate how much of each trait that user 101a is estimated to possess based on the analysis of the non-verbal cues. In step 206O, system 100 compiles the calculated scores and produces a report which, in step 207O, is provided to user 101a and user 101b. Process 200O then terminates at step 208O.

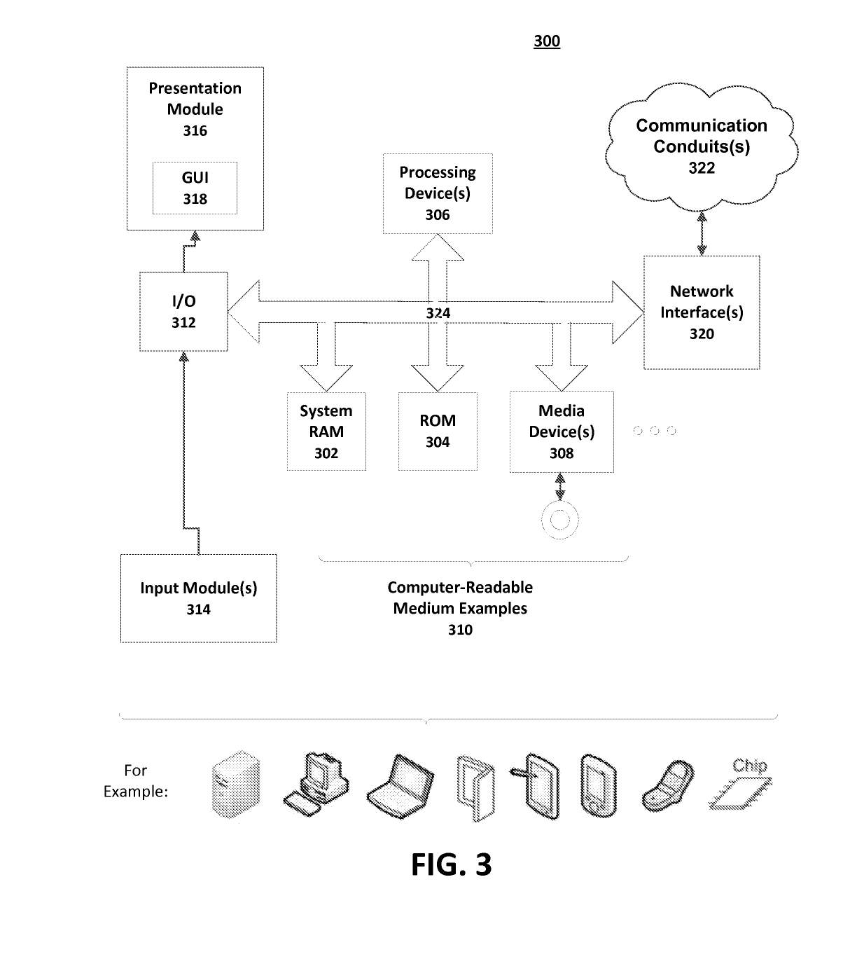

Referring now to FIG. 3, a block diagram of an exemplary computer system useful for implementing various aspects the processes disclosed herein, in accordance with one or more aspects of the present disclosure, is shown. That is, FIG. 3 sets forth illustrative computing functionality 300 that may be used to implement computing device 102a,b or any other component of system 100 (and the functionality described herein). In all cases, computing functionality 300 represents one or more physical and tangible processing mechanisms.

Computing functionality 300 may comprise volatile and non-volatile memory, such as RAM 302 and ROM 304, as well as one or more processing devices 306 (e.g., one or more central processing units (CPUs), one or more graphical processing units (GPUs), and the like). Computing functionality 300 also optionally comprises various media devices 308, such as a hard disk module, an optical disk module, and so forth. Computing functionality 300 may perform various operations identified above when the processing device(s) 306 executes instructions that are maintained by memory (e.g., RAM 302, ROM 304, and the like).

More generally, instructions and other information may be stored on any computer readable medium 310, including, but not limited to, static memory storage devices, magnetic storage devices, and optical storage devices. The term “computer readable medium” also encompasses plural storage devices. In all cases, computer readable medium 310 represents some form of physical and tangible entity. By way of example, and not limitation, computer readable medium 310 may comprise “computer storage media” and “communications media.”

“Computer storage media” comprises volatile and non-volatile, removable and non-removable media implemented in any method or technology for storage of information, such as computer readable instructions, data structures, program modules or other data. Computer storage media may be, for example, and not limitation, RAM 302, ROM 304, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 300 may also comprise an input/output module 312 for receiving various inputs (via input modules 314), and for providing various outputs (via one or more output modules). One particular output mechanism may be a presentation module 316 and an associated GUI 318. Computing functionality 300 may also include one or more network interfaces 320 for exchanging data with other devices via one or more communication conduits 322. In some aspects, one or more communication buses 324 communicatively couple the above-described components together.

Communication conduit(s) 322 may be implemented in any manner (e.g., by a local area network, a wide area network (e.g., the Internet), and the like, or any combination thereof). Communication conduit(s) 322 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “process,” “service,” “module” and “component” as used herein generally represent software, firmware, hardware or combinations thereof. In the case of a software implementation, the process, service, module or component represents program code that performs specified tasks when executed on one or more processors. The program code may be stored in one or more computer readable memory devices, as described with reference to FIG. 3. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

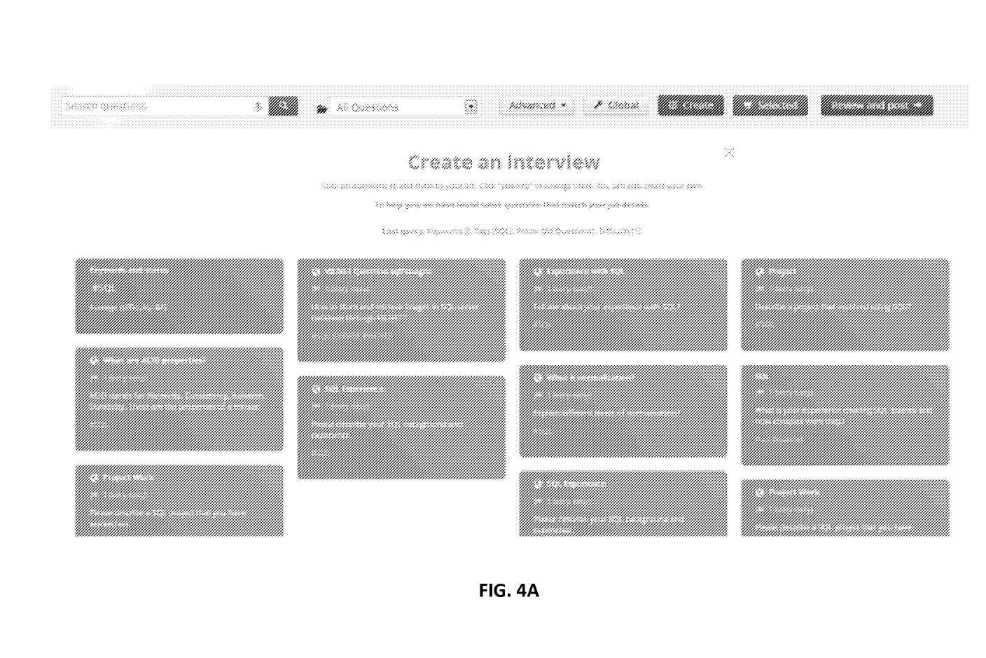

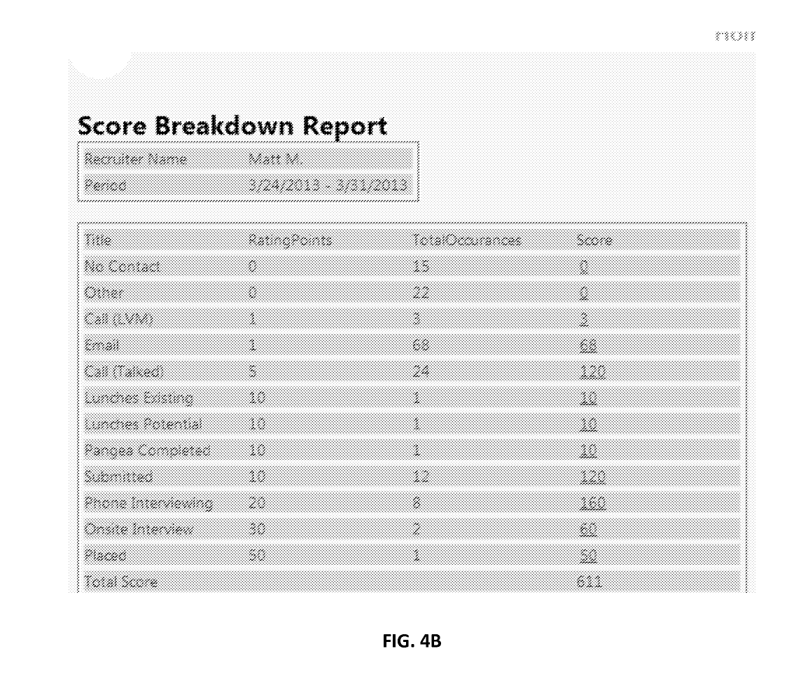

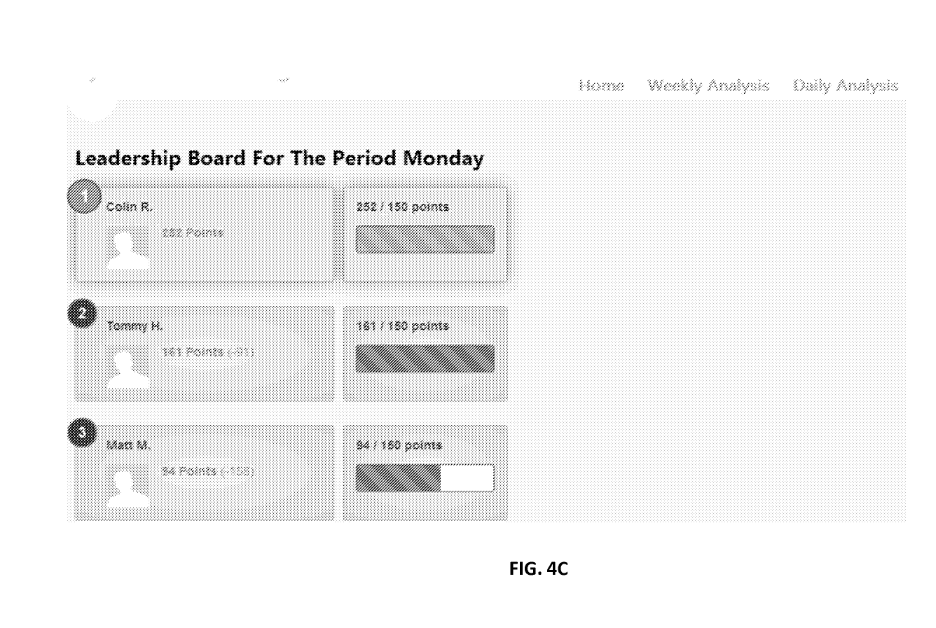

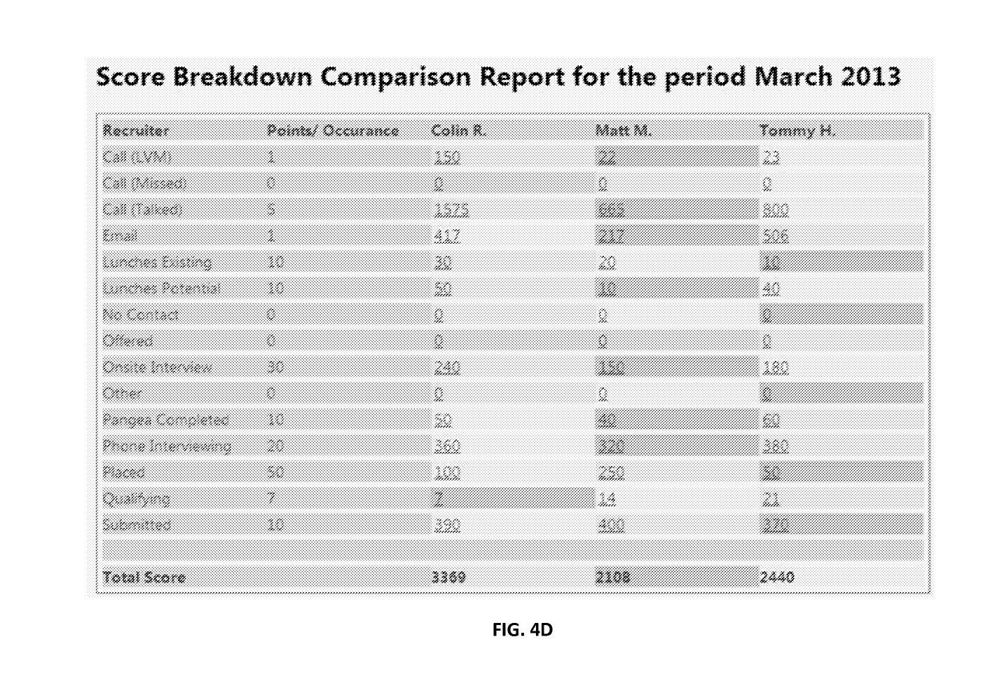

Referring now to FIG. 4A, a screenshot of an exemplary GUI display of interview questions which the system determined were relevant to the particular job posting being presented to user 101b as seen in process 200A, according to an aspect of the present disclosure, is shown. In such an aspect, user 101b uploads a job posting (not shown) into job database 103. System 100 then applies an algorithm to the job posting and presents potential questions for user 101b to consider.

Referring now to FIG. 4B, a screenshot of an exemplary GUI display of a point calculation based on activities performed by user 101a as seen in process 200K, according to an aspect of the present disclosure, is shown. In such an aspect, a point value is assigned to different activities. System 100 then calculates the total score of user 101a based on the value of the activities that user 101a performed and the frequency in which user 101a performed the activities.

Referring now to FIG. 4C, a screenshot of an exemplary GUI display of a “leaderboard” which ranks users based on a total score as seen in process 200K, according to an aspect of the present disclosure, is shown. In such an aspect, system 100 calculates the total scores of different users and presents a leaderboard to user 101b which ranks the users based on the total scores. The total scoring can be adjusted to particular time periods such as, but not limited to, daily points, weekly points, monthly points, yearly points, and “all time” points.

Referring now to FIG. 4D, a screenshot of an exemplary GUI display of a “marked up” candidate list based on each candidate's total score as seen in process 200K, according to an aspect of the present disclosure, is shown. In such an aspect, user 101b may color-code to indicate which activity scores and potential employees represent particular preferences (e.g., activity scores or employees labeled green indicate that the employee is high on the employer's list, while activity scores or employees labeled red indicates that the employee is low on the employer's list).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer implemented method for facilitating recruitment, job interviews and job seeker evaluations, the method comprising the steps of:
(a) receiving a job posting from a job poster;
(b) storing the received job posting in a jobs database;
(c) generating a series of questions and a series of model answers based on the received job posting, the series of questions being of written and video form;
(d) presenting at least a portion of the generated series of questions to a job seeker;
(e) receiving question responses from the job seeker;
(f) receiving additional cues from the job seeker corresponding with the received question responses;
(g) storing the received question responses and the received additional cues in a candidate database;
(h) analyzing, via a computing device communicatively connected to the candidate database and the jobs database, job seeker data comprising: the received question responses; and the received additional cues;
(i) generating a job seeker score from the analysis of the received question responses and the received additional cues; and
(j) rating the job seeker based on the generated job seeker score and the series of model answers.

2. The method of claim 1, comprising the additional step of:
(k) receiving a video recording of the job seeker providing the question responses;
wherein the additional cues are non-verbal cues received via the video recording.

3. The method of claim 2, wherein the additional cues are at least one of:
a speech timber; a speech pitch; a posture; a gesture; an eye contact; and an eye direction.

4. The method of claim 1, further comprising the steps of:
(k) receiving, from the job seeker, a job seeker profile; and
(l) storing the received job seeker profile in the candidate database;
wherein the job seeker data further comprises the received job seeker profile.

5. The method of claim 4, further comprising the steps of:
(m) determining, from a comparison of the job seeker profile and the job posting, if the job seeker is a potential fit for the job posting; and
(n) inviting, via an electronic invitation, the job seeker to answer at least a portion of the generated series of questions based on the received job posting.

6. The method of claim 5, wherein the electronic invitation is sent to a job seeker mobile computing device, causing the job seeker mobile computing device to produce a notification.

7. The method of claim 4, wherein the job seeker profile includes a job seeker mobile computing device identifier corresponding with a job seeker mobile computing device further comprising the steps of:
(m) determining if the job seeker mobile computing device is within a notification location via identifying the mobile computing device identifier; and
(n) inviting, via an electronic invitation, the job seeker to answer at least a portion of the generated series of questions based on the received job posting, where the job seeker mobile computing device is within the notification location.

8. The method of claim 1, further comprising the steps of:
(k) connecting to at least one job seeker social media feed; and
(l) updating the job seeker profile via the at least one job seeker social media feed.

9. The method of claim 8, wherein the job seeker updates the job seeker profile via the at least one job seeker social media feed.

10. A computer-implemented method for facilitating the evaluation of job recruiters, the method comprising the steps of:
(a) assigning recruiting activity point values to a plurality of recruiting-related tasks;
(b) storing the recruiting activity point values in a recruiter database;
(c) tracking recruiting activity of a job recruiter occurring via a job recruiter computing device;
(d) calculating a recruiter score to the job recruiter based on the tracked recruiting activity and the recruiting activity point values; and
(e) ranking the job recruiter based on the calculated recruiter score.

11. The method of claim 10, wherein the recruiting activity point values are assigned for emailing a job seeker, emailing a potential employer, making a contact, submitting a job seeker, getting a telephone interview, getting an in-person interview, and making placements.

12. The method of claim 10, wherein the recruiting activity point values may be positive or negative.

13. The method of claim 10, wherein ranking is done by comparing the calculated recruiter score to a second recruiter score, the method further comprising the step of:
(f) creating a recruiter leader board based on the ranking.

14. The method of claim 10, wherein the recruiter score is based on at least one of:
daily points, weekly points, monthly points, yearly points, and “all time” points

15. A system for facilitating recruitment, job interviews and job seeker evaluations, comprising:
(a) at least one web server capable of providing a graphical user interface, via a communications network, to a plurality of computing devices, the plurality of computing devices configured to communicate with a job seeker and a job poster;
(b) a jobs database, communicatively coupled to the at least one web server via the communications network;
(c) a candidate database communicatively coupled to the at least one web server via the communications network; and
(d) at least one application server, communicatively coupled to the at least one web server via the communications network, the at least one application server comprising:
(i) a job posting collection service capable of receiving a job posting from the job poster and storing the received job posting in the jobs database;
(ii) an interview service capable of generating a series of questions and a series of model answers based on the received job posting, the series of questions being of written and video form, presenting at least a portion of the generated series of questions to the job seeker, receiving question responses from the job seeker, receiving additional cues from the job seeker corresponding with the received question responses, and storing the received question responses and the received additional cues in the candidate database
(iii) a scoring module capable of analyzing job seeker data comprising: the received question responses; and the received additional cues, generating a job seeker score from the analysis of the received question responses and the received additional cues, and rating the job seeker based on the generated job seeker score and the series of model answers.

16. The system of claim 15, wherein the at least one application server further comprises:
(iv) a local language module capable of receiving a job seeker language preference and presenting at least a portion of the generated series of questions to the job seeker in a job seeker preferred language.

17. The system of claim 15, wherein the at least one application server further comprises:
(iv) a job seeker profile service capable of receiving, from the job seeker, a job seeker profile and storing the received job seeker profile in the candidate database, the job seeker data further comprising the received job seeker profile.

18. The system of claim 17, where the at least one application server further comprises:
(v) an invitation service capable of determining, from a comparison of the job seeker profile and the job posting, if the job seeker is a potential fit for the job posting, and inviting, via an electronic invitation, the job seeker to answer at least a portion of the generated series of questions based on the received job posting.

19. The system of claim 18, wherein the electronic invitation is sent to a job seeker mobile computing device, causing the job seeker mobile computing device to produce a notification.

20. The system of claim 17, wherein the job seeker profile includes a job seeker mobile computing device identifier corresponding with a job seeker mobile computing device and the at least one application server further comprises:
(v) a location-based invitation service capable of determining if the job seeker mobile computing device is within a notification location via identifying the mobile computing device identifier, and inviting, via an electronic invitation, the job seeker to answer at least a portion of the generated series of questions based on the received job posting, where the job seeker mobile computing device is within the notification location.
